(19) United States
(12) Patent Application Publication
(10) Pub. No.: US 2003/0101798 A1
(43) Pub. Date: Jun. 5, 2003

(54) Helicopter hollow blade pressure check and fill apparatus and method to use same

(75) Inventor: Julius Kendall, Weston, MA (US)

Correspondence Address: PERKINS, SMITH & COHEN LLP, ONE BEACON STREET, 30TH FLOOR, BOSTON, MA, 02108, US

(73) Assignee: The Entwistle Company

(21) Appl. No.: 10/007,584

(22) Filed: Dec. 5, 2001

(51) Int. Cl. G01M 3/02

(52) U.S. Cl. 73/37

(57) ABSTRACT

A hollow helicopter blade pressure check and fill system and method to use same for hollow pressurized blades is disclosed including a digital pressure sensor, a control valve, a check/fill outlet, a gas supply connector, a check valve and interconnecting tubes incorporated into a carrying case. The digital pressure sensor does not require any barometric reading or correction thereby eliminating human error. The system is used in conjunction with a conventional gas supply system connected to a hollow helicopter blade to perform accurate structure integrity and airworthiness evaluation of the blade.

### BACKGROUND OF THE INVENTION

This invention relates generally to the pressure checking and filling of a sealed vessel, and, more particularly to pressure checking and filling of helicopter rotor hollow blades to determine the structure integrity and airworthiness of the blade.

In the prior art, devices utilize absolute pressure gauges to check pressure and refill hollow helicopter blades to serviceable pressure levels require several steps to accommodate for atmospheric condition in terms of temperature for each use. An absolute pressure gauge is a gauge to measure and indicate pressure above absolute zero pressure, using absolute zero as a datum point. These devices require skill and time to setup and use. These devices also have inherent tendencies of inaccuracy due to their sensitive to environmental conditions, over-pressurization, and human error to assure blade integrity.

Over-filling or over-pressurizing, typically over 125% of full scale, the absolute pressure gauge can cause damage to internal components such as the pressure sensing element, resulting in a gauge failure, and personal injury. Over-pressuring is usually cause by misuse or misapplication. Pressure regulators, chemical seals, pulsation dampers or snubbers, syphons, or the like are installed in the system to relieve pressure to avoid catastrophic failure.

It is an object of the present invention to eliminate the initial calibration.

It is another object of the present invention to eliminate the absolute pressure gage.

It is yet another object of the present invention to reduce the time to perform the hollow blade inspection process.

It is a further object of the present invention to improve accuracy of the hollow blade inspection.

### SUMMARY OF THE INVENTION

The objects set forth above as well as further and other objects and advantages of the present invention are achieved by the embodiments of the invention described hereinbelow.

The present invention incorporates, preferably, a digital pressure sensor that does not require any barometric reading or correction. The digital pressure sensor is housed in a container including a gas control valve, a relief valve with vent, a gas supply connection, a check/fill outlet, tubing connecting the aforementioned components, and hoses to connect the present invention with the gas supply and helicopter blade. The pressure invention also includes an ambient air temperature gauge.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a schematic of the preferred embodiment of the present invention;

FIG. 2 is a pictorial of the FIG. 1 embodiment with external components to connect the present invention to a gas supply and to a hollow helicopter blade;

FIG. 3a is a pictorial of a helicopter with hollow blades;

FIG. 3b is a pictorial of the blade root end including the valve system to connect the FIGS. 1-2 embodiment and other embodiments of the present invention to the hollow helicopter blade;

FIG. 4a is a flow diagram of the hollow helicopter blade pressure checking procedure of the present invention; and

FIG. 4b-4d are flow diagrams of the hollow helicopter blade pressure checking and filling procedure of the present invention.

### DETAILED DESCRIPTION OF THE PREFERRED EMBODIMENTS

The present invention is particularly directed at helicopter blades that are hollow and pressurized. The determination of blade integrity is necessary to prevent catastrophic failure.

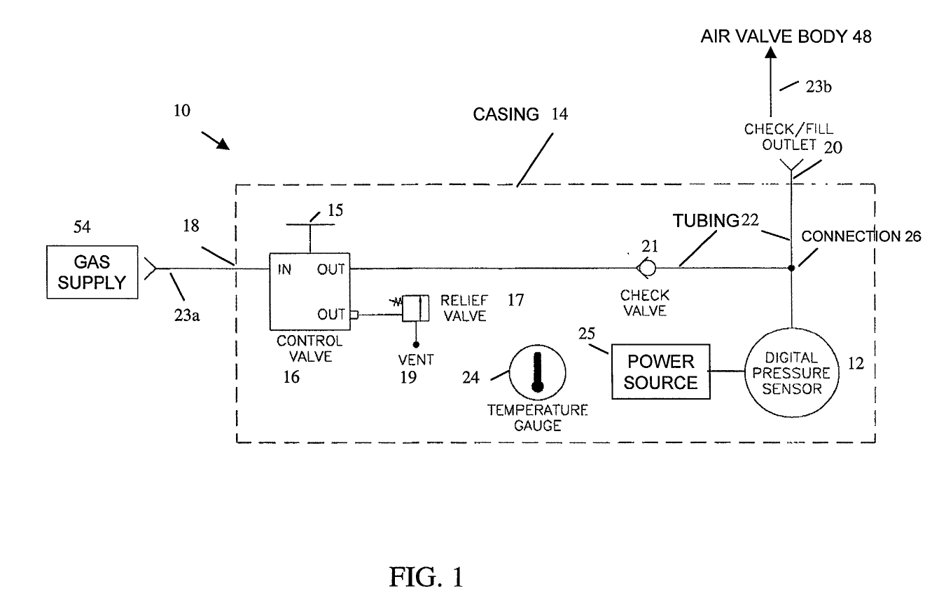

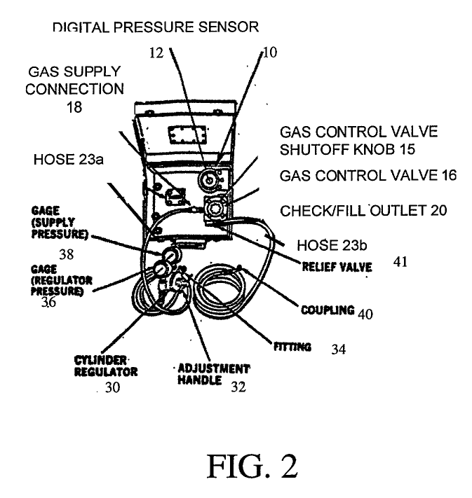

A preferred embodiment of a helicopter blade check and fill system 10 is shown in FIGS. 1 and 2. This embodiment of the system incorporates a pressure sensor 12 that does not require any barometric reading or correction. The pressure sensor 12 preferably provides a digital output powered by a conventional power source 25, preferably a battery. An example of such sensor is the Digital Pressure Test Gauge J Series line manufactured by DCT Instruments/Sensotec®, Inc. The pressure sensor 12 is housed in a case 14 including a gas control valve 16 with a shutoff knob 15, a relief valve 17 with a vent 19, a gas supply connection 18, a check/fill outlet 20, a check valve 21, and tubing 22 connecting the aforementioned components and interconnections with other tubing 22, such as connection 26 disposed between the digital pressure sensor 12 and the check/fill outlet 20. The pressure invention also includes an ambient air temperature indicator 24.

As illustrated in FIG. 2, the system 10 can further include conventional components to connect to a gas supply 54 (not shown), preferably nitrogen, and to the blade (not shown). Such components may include, but are not limited to, a gas supply line 23a, a gas filling line 23b, a cylinder regulator 30, an adjustment handle 32, a fitting 34, a regulator pressure gage 36, a supply pressure gage 38, a blade coupling 40, and a relief valve 41.

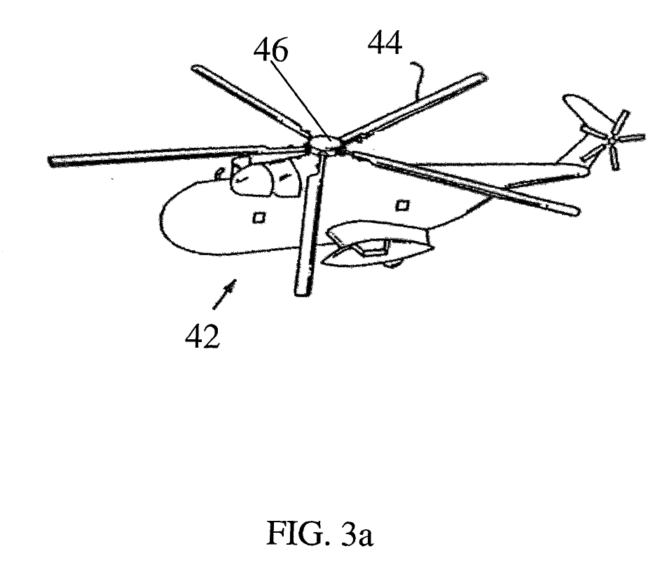

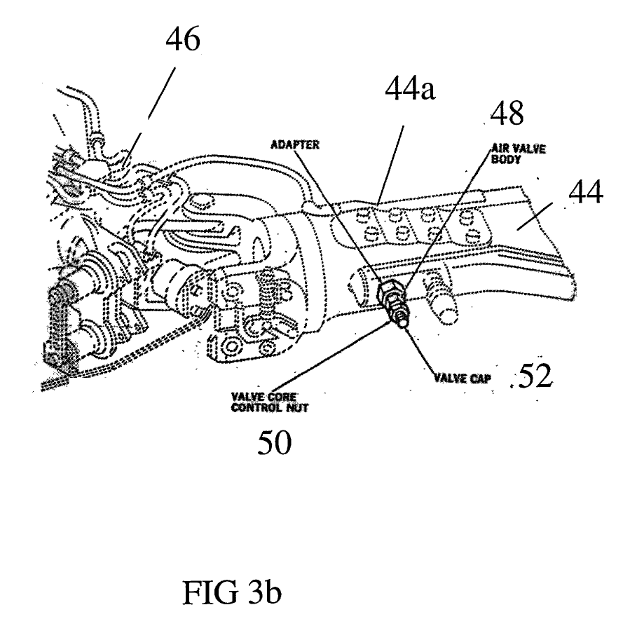

A helicopter 42 is shown in FIG. 3a with a plurality of blades 44. On each blade 44 is attached a rotating assembly 46.

Now referring to FIG. 3b, each blade 44 includes conventional components including an air valve 48, a valve core control nut 50 and a valve cap 52 at the root end 44a of the blade 44. The air valve 48 forms a passageway (not shown) from the hollow portion of the blade to the outside environment. The valve core control nut 50 opens and closes the passageway. The valve cap 52 prevents contamination particles from entering the passageway.

### MODE OF OPERATION

The system 10 has two operational modes: one as a pressure checker only and one as a pressure increaser and checker, where blade internal cavity pressure is too low to determine blade integrity. The following steps are for using the apparatus 10 only as a pressure checker. In both cases, it is desirable to allow the apparatus 10 to stabilize temperature for five minutes in the area of the blade before proceeding and then closing the control valve 16.

Referring to FIG. 1, a hose 23a is connected to a gas supply 54, preferably a nitrogen-filled bottle, and the gas supply connection 18 of the system 10. Start the flow of higher pressure fluid from the gas supply 54 to the control valve 16. Then open the control valve 16 to start flow of higher pressure fluid from the gas supply 54 to a predetermined pressure level to purge the present invention 10.

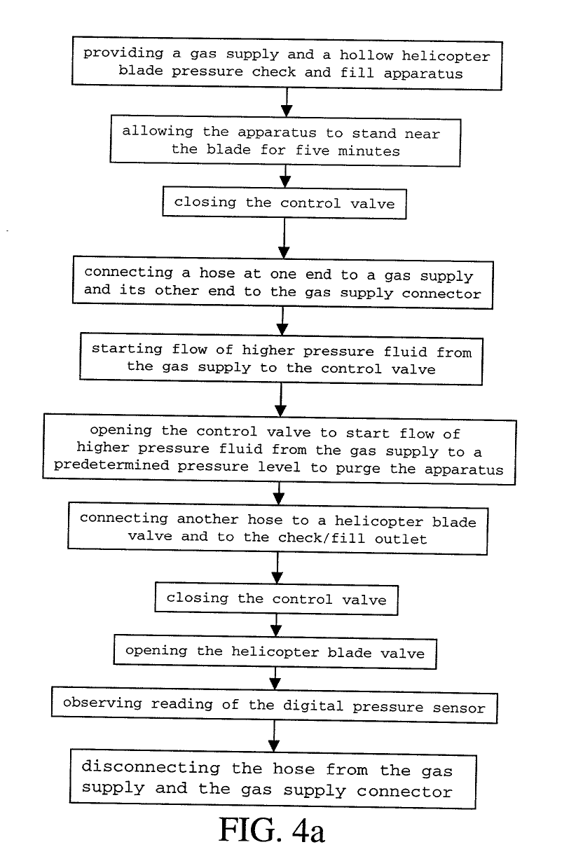

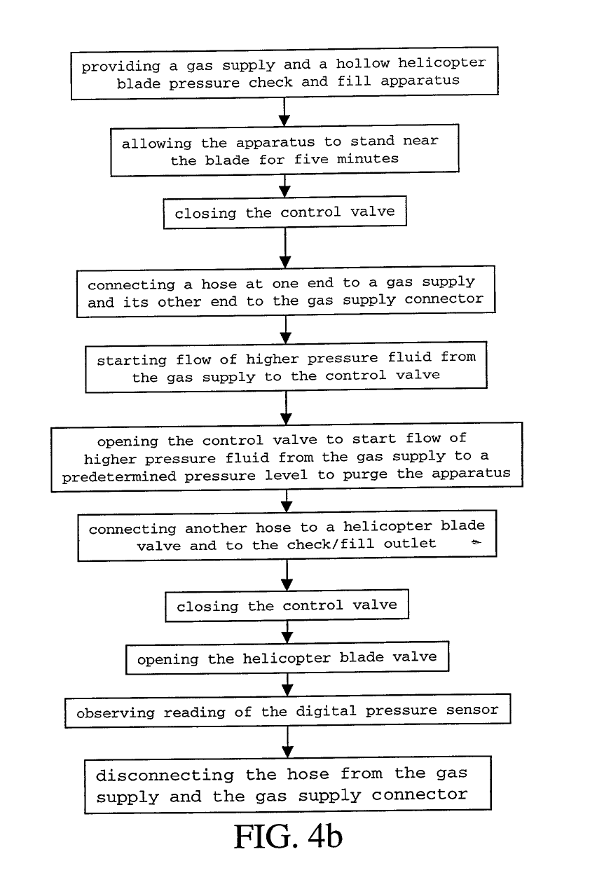

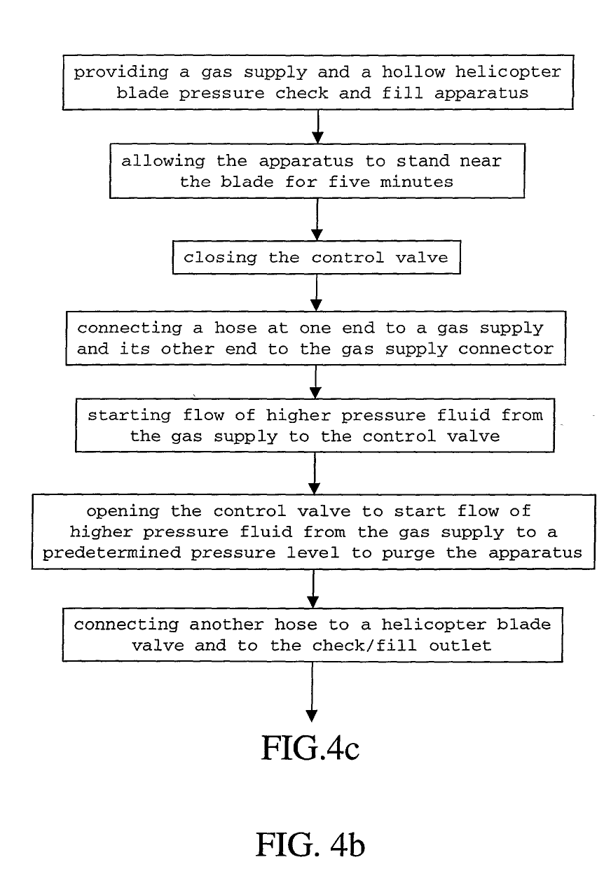

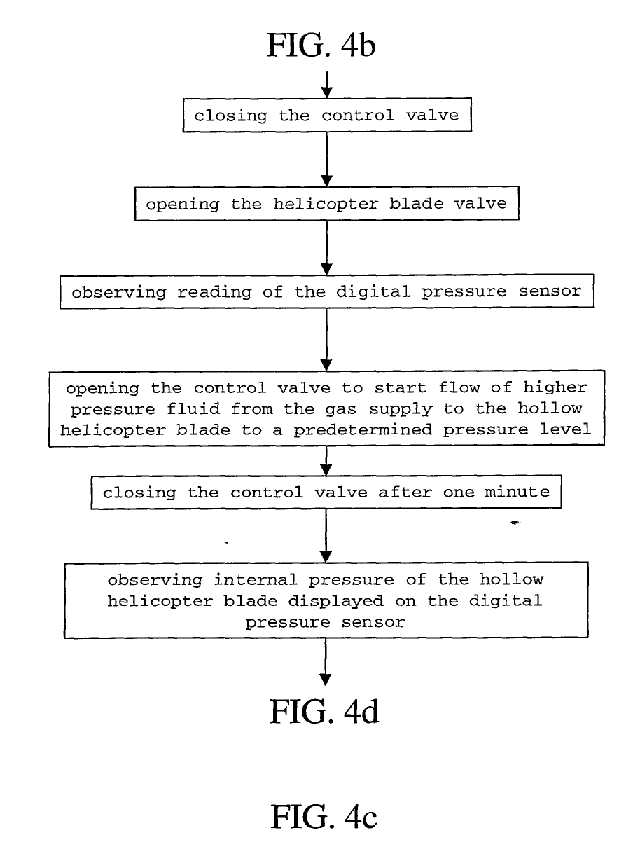

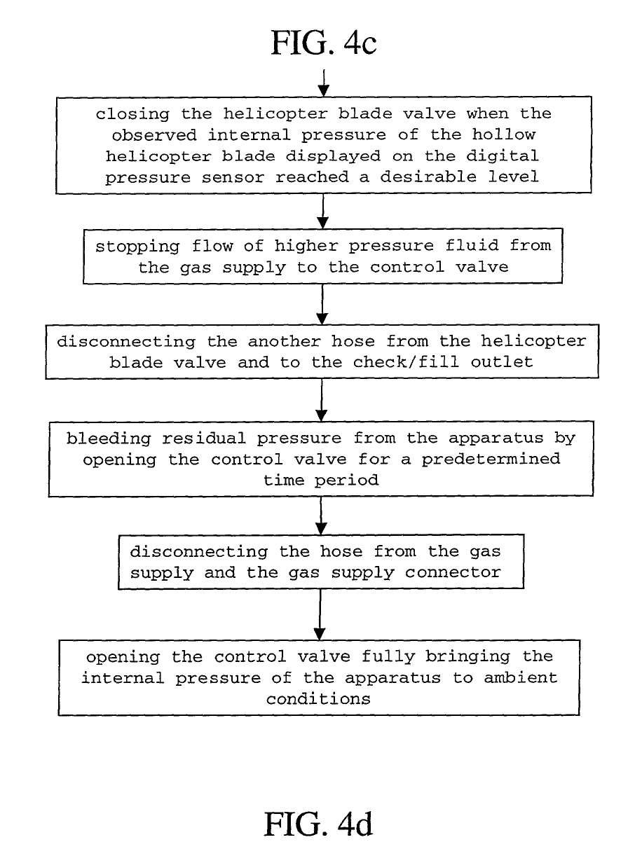

Now referring to FIGS. 2 and 3b, remove the valve cap 52 from the air valve 48 at the root end 44a of the blade 44. Connect the coupling 40 of the gas filling line 23b to the air valve body 48. Close the control valve 16, and open the helicopter blade valve core control nut 50 and note pressure sensor 12 reading. Compare pressure to a predetermined pressure level for safe flight operation. If the pressure is below acceptable limits, the cause of the pressure loss must be determined and corrected before releasing the blade 44 for flight. If the pressure is within acceptable limits, the blade 44 can be released for continued service. Upon completion of the inspection, tighten the valve core control nut 50 on the air valve 48. Close the control valve 16 after one minute. Disconnect the coupling 40 of the gas filling line 23b from the air valve body 48 and the check/fill outlet 20, and install valve cap 52. The above process is illustrated in FIG. 4a.

The second mode of operation of the apparatus 10 is a pressure booster. Follow the same procedure as described above to check the blade pressure level. Additionally, open the control valve 16 to start flow of higher pressure fluid from the gas supply 54 to the hollow helicopter blade 44 to a predetermined pressure level. Close the control valve 16 after one minute. Observe the internal pressure of the hollow helicopter blade 44 displayed on the digital pressure sensor 12. Closing the helicopter blade valve core control nut 50 when the observed internal pressure of the hollow helicopter blade 44 displayed on the digital pressure sensor 12 reaches a desirable pressure level. Repeat the filling process until the pressure stabilizes. If the pressure does not stabilize, then service is required before returning the helicopter to operation. Stop the flow of higher pressure fluid from the gas supply 54 to the control valve 16. Disconnect the hose 23b from the helicopter blade valve core control nut 50 and to the check/fill outlet 20, and install valve cap 52. Bleed residual pressure from the present invention 10 by opening the control valve 16 for a predetermined time period. Disconnect the hose 23a from the gas supply and the gas supply connector 18, and open the control valve 16 fully bringing the internal pressure of the present invention 10 to ambient conditions.

It will be apparent to those skilled in the art that other embodiments, improvements, details, and uses can be made consistent with the letter and spirit of the foregoing disclosure and within the scope of the patent, which is limited only by the following claims, construed in accordance with the patent law, including the doctrine of equivalents.

What is claimed is:

1. An apparatus for checking hollow helicopter blade pressure, comprising:
pressure sensor means; and
a pressure-tight fluid line having a first end and a second end, wherein said first end being connected to said pressure sensor means and said second end being connected to an inlet valve of a hollow helicopter blade,
whereby said pressure-tight fluid line forms a passageway between said pressure sensor means and the hollow helicopter blade allowing high pressure gas to flow between said pressure sensor means and the hollow helicopter blade.

2. The apparatus as defined in claim 1, wherein said pressure sensor means is a digital pressure sensor.

3. The apparatus as defined in claim 2, wherein said pressure sensor means is powered by a power source.

4. The apparatus as defined in claim 3, wherein said power source is a battery.

5. An apparatus for filling a hollow helicopter blade, comprising:
pressure sensor means;
a first pressure-tight fluid line having a first end and a second end, wherein said first pressure-tight fluid line being connected at said first end to said pressure sensor means and being connected at said second end to the hollow helicopter blade; and
a second pressure-tight line having an inlet end and a outlet end, said second pressure-tight line being connected at said inlet end to a gas supply and being connected at said outlet end to said first pressure-tight fluid line.

6. The apparatus as defined in claim 5, further comprising a pressure control valve connected to said second pressure-tight line to regulate flow of pressurized fluid from the gas supply to the hollow helicopter blade and said pressure sensor means.

7. The apparatus as defined in claim 6, further comprising a relief valve connected to said pressure control valve to prevent over-pressurization.

8. The apparatus as defined in claim 7, wherein said relief valve comprises a vent.

9. The apparatus as defined in claim 6, wherein said pressure sensor means is a digital pressure sensor.

10. The apparatus as defined in claim 9, wherein said pressure sensor means is powered by a power source.

11. The apparatus as defined in claim 10, wherein said power source is a battery.

12. The apparatus as defined in claim 7, further comprising a check valve disposed in said second pressure-tight fluid line between said pressure control valve and said first pressure-tight fluid line, whereby back flow from the hollow helicopter blade to said pressure control valve is prevented.

13. The apparatus as defined in claim 6, further comprising an ambient temperature gauge.

14. A method for checking hollow helicopter blade pressure, comprising the steps of:
(a) connecting one end of a pressure-tight fluid line to an inlet valve of a hollow helicopter blade and the other end of the pressure-tight fluid line to a digital pressure sensor;
(b) opening the inlet valve of the hollow helicopter blade allowing the higher than ambient pressure fluid to flow between the hollow helicopter blade and the digital pressure gauge; and
(c) monitoring internal pressure of the hollow helicopter blade displayed on the digital pressure sensor to determine whether internal pressure level is sufficient to continue flight operation.

15. A method as defined in 14, further comprising the steps:
(a) connecting one end of another pressure-tight line connected to a gas supply and its other end to the pressure-tight fluid line;
(b) starting flow of higher pressure fluid from the gas supply to the hollow helicopter blade;
(c) monitoring internal pressure of the hollow helicopter blade displayed on the digital pressure sensor to determine when internal pressure level is sufficient to continue flight operation; and
(d) stopping flow of higher pressure fluid from the gas supply to the hollow helicopter blade when internal pressure of the hollow helicopter blade is sufficient to continue flight operation.

16. A method for checking internal pressure of a hollow helicopter blade, comprising the steps of:
(a) providing a gas supply and a hollow helicopter blade pressure checking apparatus having a control valve, a digital pressure sensor, a check/fill outlet, and a gas supply connector;
(b) allowing the apparatus to stand near the blade for five minutes to equalize apparatus temperature;
(c) closing the control valve;
(d) connecting a hose at one end to a gas supply and its other end to the gas supply connector;
(e) starting flow of higher pressure fluid from the gas supply to the control valve;
(f) opening the control valve to start flow of higher pressure fluid from the gas supply to a predetermined level to purge the apparatus;
(g) connecting another hose to a helicopter blade valve and to the check/fill outlet;
(h) closing the control valve;
(i) opening the helicopter blade valve;
(j) observing reading of the digital pressure sensor;
(k) closing the helicopter blade valve;
(l) stopping flow of higher pressure fluid from the gas supply to the control valve;
(m) disconnecting the another hose from the helicopter blade fitting and to the check/fill outlet;
(n) bleeding residual pressure from the apparatus by opening the control valve for a predetermined time period;
(o) disconnecting the hose from the gas supply and the gas supply connector; and
(p) opening the control valve fully.

17. A method for filling and checking structural integrity of a hollow helicopter blade, comprising the steps of:
(a) providing a gas supply and a hollow helicopter blade pressure check and fill apparatus having a control valve, a digital pressure sensor, a check/fill outlet, and a gas supply connector;
(b) allowing the apparatus to stand near the blade for five minutes to equalize apparatus temperature;
(c) closing the control valve;
(d) connecting a hose at one end to a gas supply and its other end to the gas supply connector;
(e) starting flow of higher pressure fluid from the gas supply to the control valve;
(f) opening the control valve to start flow of higher pressure fluid from the gas supply to a predetermined pressure level to purge the apparatus;
(g) connecting another hose to a helicopter blade valve and to the check/fill outlet;
(h) closing the control valve;
(i) opening the helicopter blade valve;
(j) observing reading of the digital pressure sensor;
(k) opening the control valve to start flow of higher pressure fluid from the gas supply to the hollow helicopter blade to a predetermined pressure level;
(l) closing the control valve after a predetermined time period;
(m) observing internal pressure of the hollow helicopter blade displayed on the digital pressure sensor;
(n) closing the helicopter blade valve when the observed internal pressure of the hollow helicopter blade displayed on the digital pressure sensor reached a desirable level;
(o) stopping flow of higher pressure fluid from the gas supply to the control valve;
(p) disconnecting the another hose from the helicopter blade valve and to the check/fill outlet;
(q) bleeding residual pressure from the apparatus by opening the control valve for a predetermined time period;
(r) disconnecting the hose from the gas supply and the gas supply connector; and
(s) opening the control valve fully bringing the internal pressure of the apparatus to ambient conditions.

18. The method as defined in claim 17, wherein the predetermined time period of step (1) is one minute.
